(19) United States
(12) Patent Application Publication
(10) Pub. No.: US 2020/0065368 A1
(43) Pub. Date: Feb. 27, 2020

(54) IMPLEMENTING ENHANCED AUTOCOMPLETE VIA MULTIPLE MOBILE KEYBOARDS

(71) Applicant: International Business Machines Corporation, Armonk, NY (US)

(72) Inventors: Aditi Rajagopal, Rochester, MN (US); Bradley L. Manning, Rochester, MN (US); Charles Volzka, Rochester, MN (US); James E. Carey, Rochester, MN (US)

(21) Appl. No.: 16/111,994

(22) Filed: Aug. 24, 2018

(51) Int. Cl. G06F 17/27; G06F 3/0488

(52) U.S. Cl. CPC G06F 17/273; G06F 3/016; G06F 17/2735; G06F 3/04886

(57) ABSTRACT

A method, system and computer program product are provided for implementing enhanced autocomplete via multiple mobile keyboards. A user input is mapped to other keys to identify a meaningful message. When a meaningful message is not identified, the user input is compared with text using other keyboards for the mobile device. When a meaningful message is identified, the user input is automatically corrected.

### FIELD OF THE INVENTION

The present invention relates generally to the data processing field, and more particularly, relates to a method, system and computer program product for implementing enhanced autocomplete via multiple mobile keyboards.

### DESCRIPTION OF THE RELATED ART

On any mobile device, typically switching is required between multiple keyboards, such as letters, numbers, punctuation, emojis and sometimes other languages. A certain population is able to text without looking at the mobile screen. Sometimes when people text without looking at the screen, they forget to toggle between keyboards, for example, resulting in punctuation gibberish (‘;,[ ];]’;23) rather than the intended words.

A need exists for an efficient and effective mechanism for implementing enhanced autocomplete via multiple mobile keyboards and autocorrection of a mobile keyboard.

### SUMMARY OF THE INVENTION

Principal aspects of the present invention are to provide a method, system and computer program product for implementing enhanced autocomplete via multiple mobile keyboards. Other important aspects of the present invention are to provide such method, system and computer program product substantially without negative effects and that overcome many of the disadvantages of prior art arrangements.

In brief, a method, system and computer program product are provided for implementing enhanced autocomplete via multiple mobile keyboards. A user input is mapped to other keys to identify a meaningful message. When a meaningful message is not identified, the user input is compared with text using other keyboards for the mobile device. When a meaningful message is identified, the user input is automatically corrected.

In accordance with features of the invention, mapping of the user text is performed, for example, using key proximity, frequency, and location of the user key touches to identify a meaningful message.

In accordance with features of the invention, when a meaningful message is identified, the user is notified with a haptic, audio or visual alert presented to the user. The user then has the option to switch to replace the current keyboard's output with the suggested keyboard's output.

In accordance with features of the invention, pattern matching is used to identify intent of a user when the words are typed on a wrong keyboard of the mobile device and then the typed words are autocorrected.

In accordance with features of the invention, when a series of punctuation or numerical symbols are typed, the series of user input is mapped to the alphabetical keys to determine whether there is a word or series of words that can be typed. For example, via a phone dictionary and language are used determine if the input represents a meaningful message, if not checking with another keyboard is performed, if the message then makes sense, a correction is made.

In accordance with features of the invention, user input text is mapped to a most common keyboard and if that fails, the current user input text is passed for processing at another set of keyboards including previous recently used keyboards.

In accordance with features of the invention, when a user is typing on the screen as if there is a keyboard when there is no keyboard displayed, then this is processed by bringing up a keyboard and checking the input text already entered by using key proximity, frequency, and location of key touches or patterns to try to identify the intent of the user and to bring up the correct keyboard

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 provides a block diagram of an example mobile computer system for implementing enhanced autocomplete via multiple mobile keyboards in accordance with preferred embodiments;

FIG. 2 is a flow chart illustrating example system operations to implement enhanced autocomplete via multiple mobile keyboards of FIG. 1 in accordance with preferred embodiments;

FIGS. 3A, 3B, and 3C illustrate example system keyboard operations to implement enhanced autocomplete via multiple mobile keyboards of FIG. 1 in accordance with preferred embodiments; and

FIG. 4 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and mobile system are provided for implementing enhanced autocomplete via multiple mobile keyboards. A user opens an application on a mobile device and inputs text. When a meaningful message is not identified, mapping the text input to other keys is performed. Pattern matching is used to identify intent of a user when the words are typed on a wrong e-keyboard and then the typed words are autocorrected.

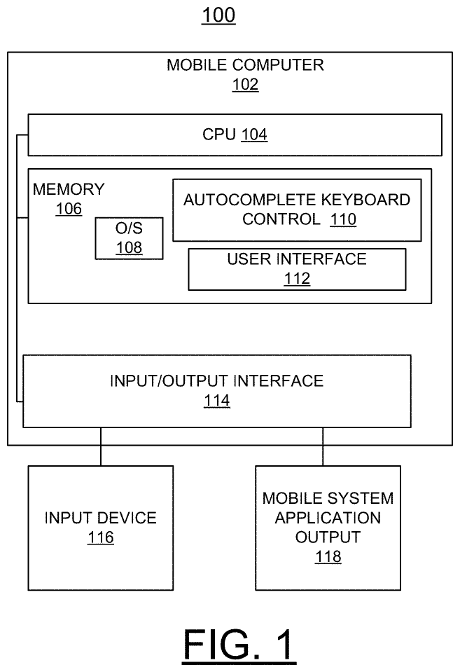

Having reference now to the drawings, in FIG. 1, there is shown an example mobile s system embodying the present invention generally designated by the reference character 100 for implementing enhanced autocomplete via multiple mobile keyboards in accordance with preferred embodiments. Mobile system 100 includes a computer system 102 including one or more processors 104 or general-purpose programmable central processing units (CPUs) 104. As shown, computer system 102 includes a single CPU 104; however, system 102 can include multiple processors 104.

Computer system 102 includes a system memory 106 including an operating system 108, an autocomplete keyboard control 110 in accordance with preferred embodiments, and a user interface 112. System memory 106 is a random-access semiconductor memory for storing data, including programs. System memory 106 is comprised of, for example, a dynamic random access memory (DRAM), a synchronous direct random access memory (SDRAM), a current double data rate (DDRx) SDRAM, non-volatile memory, optical storage, and other storage devices.

Computer system 102 includes an input/output interface 114 connected to an input device 116 and a client system application output 118 of the mobile system 100 in accordance with preferred embodiments.

Mobile devices often use soft or e-keyboards for written user input. These keyboards use a section of the screen to display a virtual keyboard with which the user interacts. Users may also switch between various keyboards for multiple languages or functional purposes. Proficient users may interact with these keyboard without looking at the screen.

In accordance with features of the invention, when a user attempts to create a message believing a different keyboard is displayed than what is actually on screen, position is recorded of all touches to the keyboard. When the user enters a series of touches, the current virtual keyboard's output is examined and is then checked with a dictionary of output for the keyboard to determine if the output represents a meaningful message. If it does not, the same position of touches is checked against other available soft keyboards for the device. If the output of one of those other keyboards matches dictionary values then a haptic, audio or visual alert is presented to the user. The user then has the option to switch to replace the current keyboard's output with the suggested keyboard's output.

In accordance with features of the invention, mapping the location of particular numbers and symbols on one mobile keyboard to the letters on another mobile keyboard is used to provide effective autocomplete. If a series of punctuation or numerical symbols are typed, they are mapped to the alphabetical keys to determine whether there is a word or series of words that can be typed. For example, via the phone dictionary and language are used determine if the input represents a meaningful message, if not checking with another keyboard is performed, if the message then makes sense, a correction is made.

In accordance with features of the invention, the new enhanced autocomplete keyboard control extends the scope of autocorrect to span multiple keyboards with processing multiple mobile keyboards ensuring client system application output is reasonable, effectively addressing autocorrect functionality. For example, on smart phone, such as an Apple iPhone, “2$-5:9 697 2-!5;94:8!!4” translates to “what do you want for dinner”—by detecting that “2$-5” does not have meaning in the dictionary, the new enhanced autocomplete keyboard control checks what the mapping is on a different keyboard, and therefore would detect “what.” Since “what” has some meaning, the iPhone can suggest “what” via autocomplete. In addition, if the user keeps typing and writes “2$-5:9” the new enhanced autocomplete keyboard control can automatically switch the keyboard for the user. Also incorrect finger placement on a keyboard can be detected and corrected.

In accordance with features of the invention, user input text is mapped to a most common keyboard and if that fails to identify a meaningful message, the current user input text is passed for processing at another set of keyboards including previous recently used keyboards. When a user is typing on the screen as if there is a keyboard when there is no keyboard displayed, then this is processed by bringing up a keyboard and checking the input text already entered by using key proximity, frequency, and location of key touches or patterns to try to identify the intent of the user and to bring up the correct keyboard.

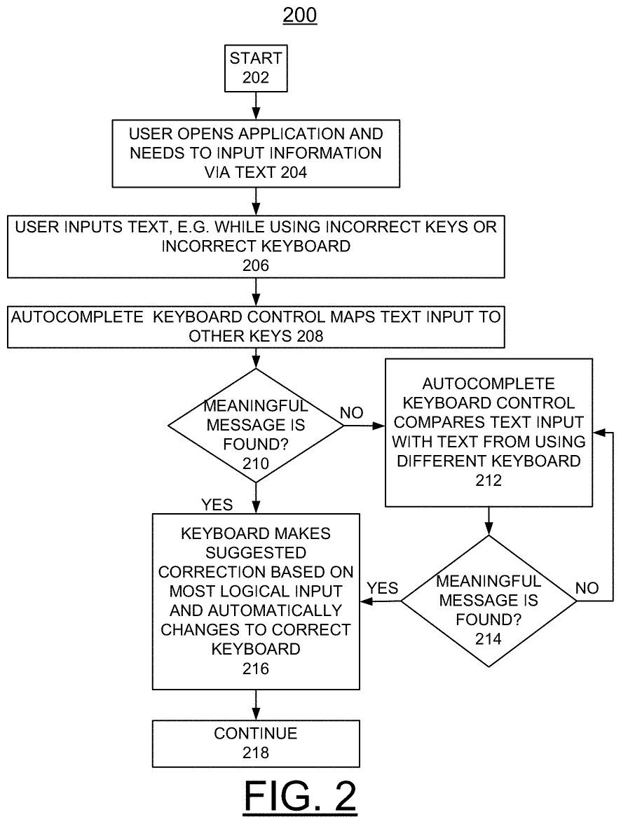

Referring to FIG. 2, there are shown example system operations generally designated by the reference characters 200 of computer system 102 of FIG. 1, for implementing enhanced autocomplete via multiple mobile keyboards in accordance with preferred embodiments starting at a block 202. As indicated at a block 204, a user opens an application and needs to input information via text. As indicated in a block 206, the user inputs text, for example, while using incorrect keys or an incorrect keyboard. As indicated in a block 208, autocomplete keyboard control 110 maps the user input to other keys, for example, using key proximity and pattern matching. As indicated in a decision block 210, checking is performed to identify whether a meaningful message is found. As indicated in a block 212, when a meaningful message is not found, then the autocomplete keyboard control 110 compares the text input with text from using a different keyboard. As indicated in a decision block 214, checking is performed to identify whether a meaningful message is found. When a meaningful message is not found, then the autocomplete keyboard control 110 compares the text input with text from using a different keyboard returning to block 212. When a meaningful message is found, the keyboard makes suggested correction based on most logical input and automatically changes to correct keyboard as indicated in a block 216. Then operations continue as indicated in a block 218.

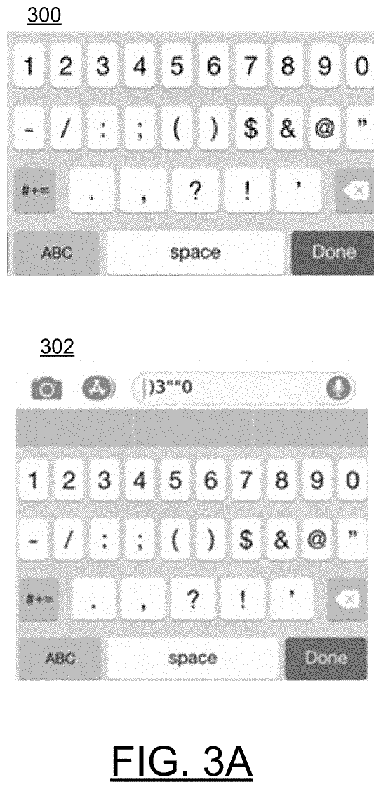

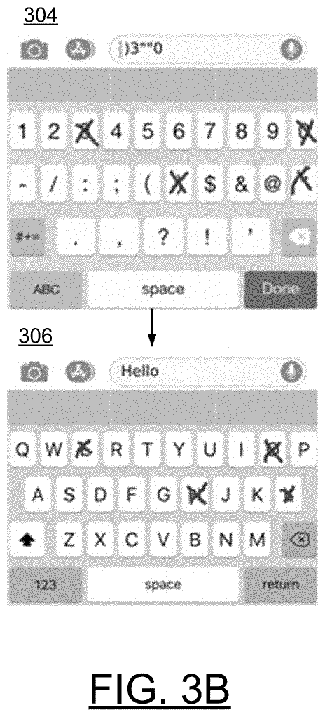

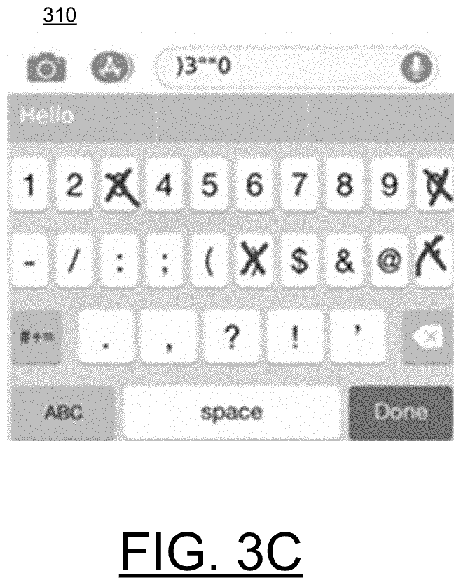

Referring now to FIGS. 3A, 3B, and 3C, there are shown example system keyboard operations to implement enhanced autocomplete via multiple mobile keyboards of FIG. 1 in accordance with preferred embodiments. In FIG. 3A, a first e-keyboard generally designated by reference character 300 is shown.

In FIG. 3B at the top, a next e-keyboard generally designated by reference character 304 is shown with an example user entry of)3**0 and an X on the keys for the example user entry of)3**0. In FIG. 3B at the bottom, a next e-keyboard generally designated by reference character 306 after processing by the autocomplete keyboard control 110 optionally is shown with a display showing text Hello to notify the user of possible corrected text so that the user is given the option to switch to replace the current keyboard's output with the suggested possible corrected text.

In FIG. 3C, a next e-keyboard generally designated by reference character 310 is shown with the example user entry of)3**0 and an X on the keys for the example user entry of)3**0 with the autocorrected text Hello displayed below the example user entry.

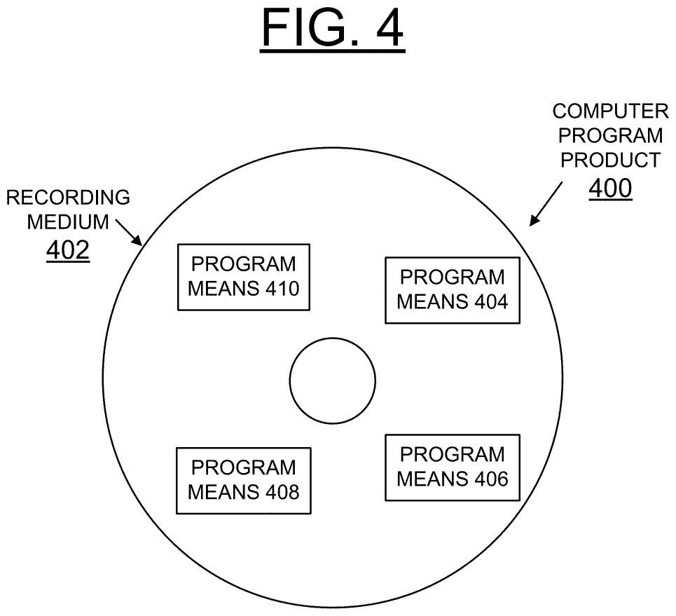

Referring now to FIG. 4, an article of manufacture or a computer program product 400 of the invention is illustrated. The computer program product 400 is tangibly embodied on a non-transitory computer readable storage medium that includes a recording medium 402, such as, a floppy disk, a high capacity read only memory in the form of an optically read compact disk or CD-ROM, a tape, or another similar computer program product. The computer readable storage medium 402, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Recording medium 402 stores program means or instructions 404, 406, 408, and 410 on the non-transitory computer readable storage medium 402 for carrying out the methods for implementing enhanced autocomplete via multiple mobile keyboards in the mobile system 100 of FIG. 1.

Computer readable program instructions 404, 406, 408, and 410 described herein can be downloaded to respective computing/processing devices from a computer readable storage medium or to an external computer or external storage device via a network, for example, the Internet, a local area network, a wide area network and/or a wireless network. The computer program product 400 may include cloud based software residing as a cloud application, commonly referred to by the acronym (SaaS) Software as a Service. The network may comprise copper transmission cables, optical transmission fibers, wireless transmission, routers, firewalls, switches, gateway computers and/or edge servers. A network adapter card or network interface in each computing/processing device receives computer readable program instructions 404, 406, 408, and 410 from the network and forwards the computer readable program instructions for storage in a computer readable storage medium within the respective computing/processing device.

A sequence of program instructions or a logical assembly of one or more interrelated modules defined by the recorded program means 404, 406, 408, and 410, direct the system 100 for implementing enhanced autocomplete via multiple mobile keyboards of the preferred embodiment.

While the present invention has been described with reference to the details of the embodiments of the invention shown in the drawing, these details are not intended to limit the scope of the invention as claimed in the appended claims.

What is claimed is:

1. A computer system for implementing enhanced autocomplete via multiple mobile keyboards in a mobile device comprising:
a processor;
a processor using an autocomplete keyboard control to implement enhanced autocomplete via multiple mobile keyboards comprising;
mapping a user input to other keys to identify a meaningful message;
when a meaningful message is not identified, comparing the user input with text from other keyboards of the mobile device; and
when a meaningful message is identified, automatically correcting the user input.

2. The computer system as recited in claim 1, wherein mapping a user input to other keys to identify a meaningful message includes mapping the user input using key proximity, frequency, and location of the user key touches to identify a meaningful message.

3. The computer system as recited in claim 1, comprises when a meaningful message is identified, notifying the user with a haptic, audio or visual alert presented to the user.

4. The computer system as recited in claim 3, further comprising providing the user with an option to switch to replace a current keyboard with a suggested keyboard.

5. The computer system as recited in claim 1, comprises using pattern matching to identify intent of a user when words are typed on a wrong keyboard of the mobile device and then autocorrecting the typed words.

6. The computer system as recited in claim 1, comprises using a phone dictionary and language to determine if the user input represents a meaningful message.

7. The computer system as recited in claim 1, wherein mapping a user input to other keys to identify a meaningful message includes mapping user input text to a most common keyboard and if that fails, the user input text is passed for processing at another set of keyboards including recently used keyboards.

8. The computer system as recited in claim 1, comprises receiving a user input with no keyboard displayed, bringing up a keyboard to determine if the user input represents a meaningful message.

9. The system as recited in claim 1 includes control code stored on a non-transitory computer readable medium, and wherein said control code is used for implementing enhanced autocomplete via multiple mobile keyboards in a mobile device.

10. A method for implementing enhanced autocomplete via multiple mobile keyboards in a mobile device comprising:
providing a an autocomplete keyboard control, said autocomplete keyboard control embodied in a non-transitory machine readable medium used to implement autocomplete via multiple mobile keyboards; said trigger program control logic:
mapping a user input to other keys to identify a meaningful message;
when a meaningful message is not identified, comparing the user input with text from other keyboards of the mobile device; and
when a meaningful message is identified, automatically correcting the user input.

11. The method as recited in claim 10, wherein mapping a user input to other keys to identify a meaningful message includes mapping of the user input using key proximity, frequency, and location of the user key touches to identify a meaningful message.

12. The method as recited in claim 10, comprises when a meaningful message is identified, notifying the user with a haptic, audio or visual alert presented to the user.

13. The method as recited in claim 12, further comprising providing the user with an option to switch to replace a current keyboard with a suggested keyboard.

14. The method as recited in claim 10, comprises using pattern matching to identify intent of a user when words are typed on a wrong keyboard of the mobile device and then autocorrecting the typed words.

15. The method as recited in claim 10, comprises using a phone dictionary and language to determine if the user input represents a meaningful message.

16. The method as recited in claim 10, wherein mapping a user input to other keys to identify a meaningful message includes mapping user input text to a most common keyboard and if that fails, the user input text is passed for processing at another set of keyboards including recently used keyboards.

17. The method as recited in claim 10, comprises receiving a user input with no keyboard displayed, bringing up a keyboard to determine if the user input represents a meaningful message.

18. The method as recited in claim 10, further comprising checking the user input by using key proximity, frequency, and location of key touches to identify the intent of the user and to bring up a correct keyboard.

19. The method as recited in claim 10, comprises receiving a user input of a series of punctuation and numerical symbols, mapping the series to alphabetical keys to determine if the user input represents a meaningful message.

20. The method as recited in claim 10, further comprising checking using another keyboard of multiple keyboards for identifying a meaningful message.
